(19) United States
(12) Patent Application Publication
(10) Pub. No.: US 2010/0212844 A1
(43) Pub. Date: Aug. 26, 2010

(54) ROLLER SHADE AND MANUFACTURING METHOD THEREOF

(76) Inventor: Gow-Ten Chien, Chung Ho City (TW)

Correspondence Address: LEONG C LEI, PMB # 1008, 1867 YGNACIO VALLEY ROAD, WALNUT CREEK, CA, 94598, US

(21) Appl. No.: 12/391,272

(22) Filed: Feb. 24, 2009

(51) Int. Cl. E06B 9/42

(52) U.S. Cl. 160/323.1; 160/405

(57) ABSTRACT

The roller shade is provided which contains a transparent first fabric piece, a transparent second fabric piece, and a third fabric piece composed of a number of transparent lateral sections and opaque lateral sections alternately pieced together. The third fabric piece is sandwiched between the first and second fabric pieces. The first, second, and third fabric pieces are pulled through a device which contains two extensible arms capable of conducting high-frequency fusion. The two extensible arms alternately press the third fabric piece against the first and second fabric pieces at appropriate intervals and conduct high-frequency fusion so that any two adjacent transparent lateral sections are fused to the first and second fabric pieces, respectively, while the opaque sections are thereby held between the first and second fabric pieces.

### (a) TECHNICAL FIELD OF THE INVENTION

The present invention generally relates to roller shades, and more particularly to a roller having adjustable transmittance and a manufacturing method of the roller shade.

### (b) DESCRIPTION OF THE PRIOR ART

A convention window roller shade for blocking sunlight is usually composed of a long piece of fabric rolled around a roller on the top rim of the window. When needed, the roller shade is pulled down to cover the window entirely or partially to prevent sunlight from passing through. It is then rolled back up when there is no sunlight or when the roller shade is not used. This type of conventional roller shade is usually completely opaque and the only way to adjust the amount of admitted sunlight is through controlling how long the roller shade is released, which is not quite convenient and flexible. To overcome this, there are teachings where the roller shade is composed of two parallel pieces of fabric and a number of opaque strips of fabric attached between the two parallel pieces. However, these opaque strips of fabrics are often deformed when the roller shade is used.

### SUMMARY OF THE INVENTION

As such, a novel roller shade is provided which contains a transparent first fabric piece, a transparent second fabric piece, and a third fabric piece composed of a number of transparent lateral sections and opaque lateral sections alternately pieced together. The third fabric piece is sandwiched between the first and second fabric pieces.

The first, second, and third fabric pieces are pulled through a device which contains two extensible arms capable of conducting high-frequency fusion. The two extensible arms alternately press the third fabric piece against the first and second fabric pieces at appropriate intervals and conduct high-frequency fusion so that any two adjacent transparent lateral sections are fused to the first and second fabric pieces, respectively, while the opaque sections are thereby held between the first and second fabric pieces.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the various components of the device of forming the roller shade of the present invention.

FIGS. 2 to 4 are schematic diagrams showing the scenarios of forming the roller shade of the present invention.

FIGS. 5A and 5B are schematic diagrams showing the structure of the roller shade of the present invention.

FIGS. 6A and 6B are schematic diagrams showing the structure of the roller shade of the present invention adjusted to alter the roller shade's transmittance.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

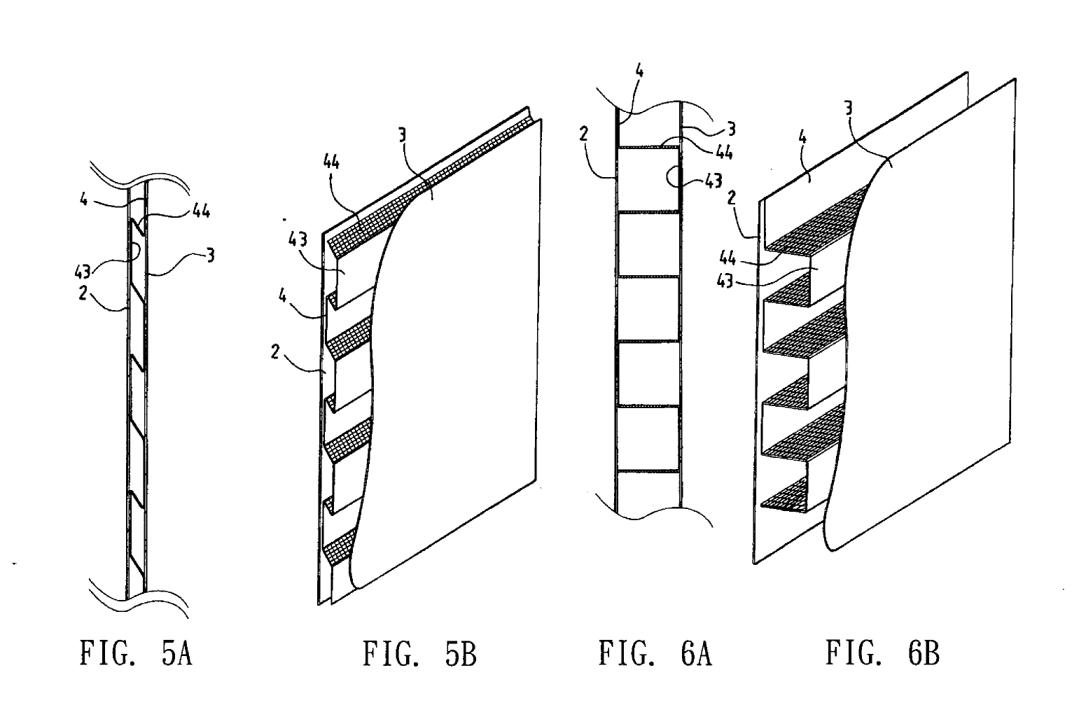

FIGS. 5A and 5B show a roller shade according to an embodiment of the present invention. As illustrated, the roller shade contains a transparent first fabric piece 2, a transparent second fabric piece 3 parallel to the first fabric piece 2, and a third fabric piece 4 sandwiched between the first and second fabric pieces 2 and 3. The third fabric piece 4 contains a number of transparent lateral sections 43 and opaque lateral sections 44 alternately pieced together along their lateral edges. The third fabric piece 4 is arranged between the first and second fabric pieces 2 and 3 such that any two adjacent transparent lateral sections 43 are flatly attached to the first and second fabric pieces 2 and 3, respectively, while the opaque sections 44 are thereby held between the first and second fabric pieces 2 and 3 and parallel to each other. When the first and second fabric pieces 2 and 3 are freely hung from a same height, the opaque sections 44 would be substantially perpendicular to the first and second fabric pieces 2 and 3 and therefore do not block the light penetrating through the first and second fabric pieces 2 and 3.

However, as shown in FIGS. 6A and 6B, when one of the first and second fabric pieces 2 and 3 is pulled higher than the other one, the opaque sections 44 are slanted to block the light or portion of the light penetrating through the first and second fabric pieces 2 and 3. In other words, by adjusting the relative heights of the transparent first and second fabric pieces 2 and 3 to alter the slope of the opaque sections 44 of the third fabric piece 4, different amount of light could be blocked or allowed through the roller shade.

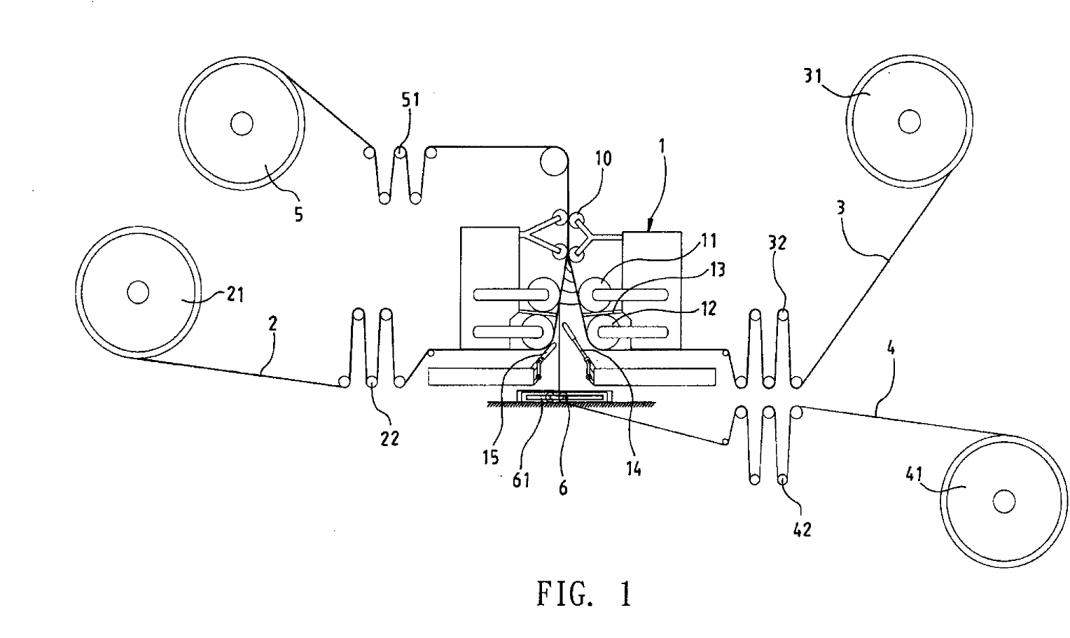

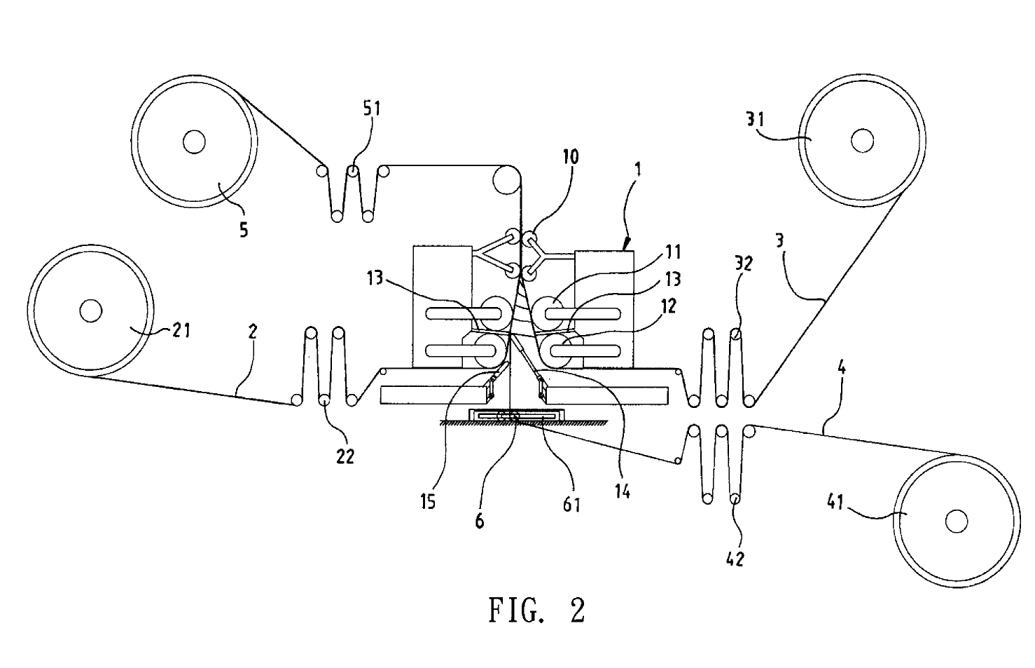

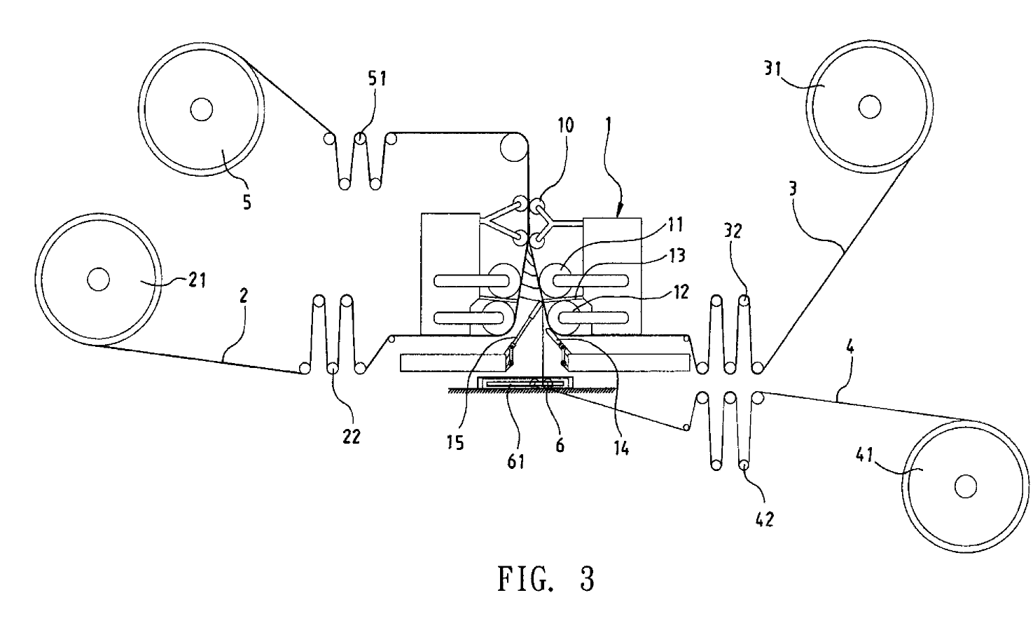

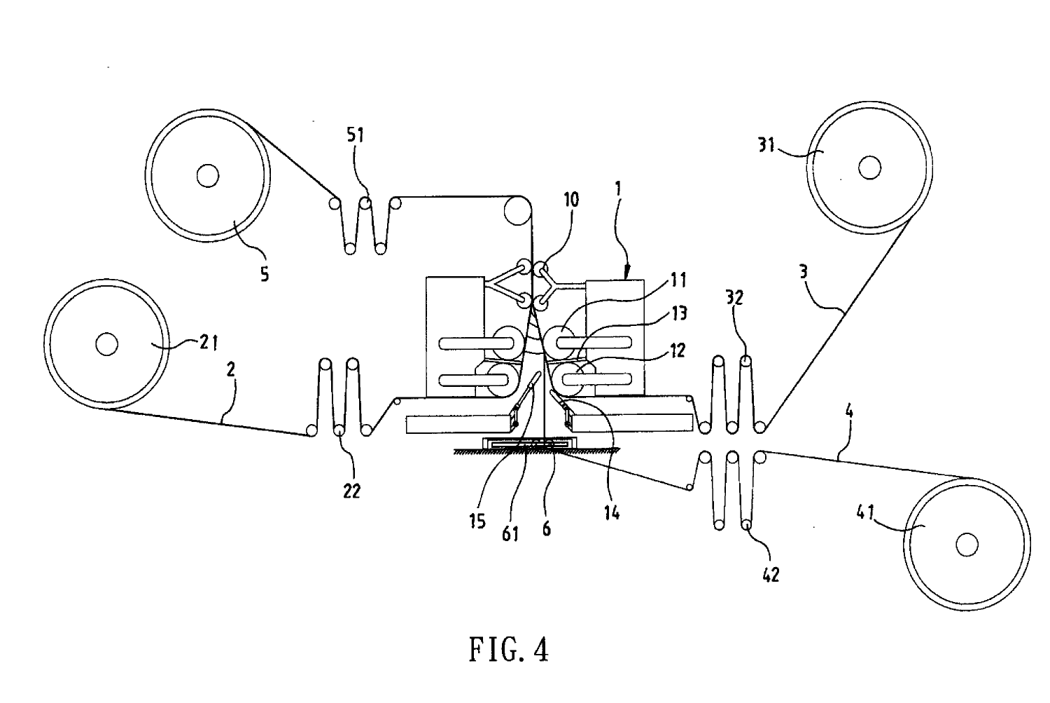

Please refer to FIGS. 1 to 4. To manufacture the roller shade as described above, the first fabric piece 2 is wound around a first roller 21, the second fabric piece 3 is wound around a second roller 31, the third fabric piece 4 is wound around a third roller 41, and the first, second, and third fabric pieces 2, 3, and 4 are pulled through tension adjustors 22, 32, and 42, respectively, so that the first, second, and third fabric pieces 2, 3, and 4 are maintained at an appropriate tension, and then joined together by a device 1 into the roller shade of the present invention. The roller shade is wound around a fourth roller 5 via a tension adjustor 51.

The device 1 is provided as follows. The device 1 has a front opening where the first, second, and third fabric pieces 2, 3, and 4 are pulled into the device 1 and a back opening where the resultant roller shade is pulled out of the device 1. At the back opening, there is a pair of pressure wheels 10 through which the first, second, and third fabric pieces 2, 3, and 4 are tightly and reliably adhered together into the resultant roller shade of the present invention.

At the front opening, there is a pair of first stretching wheels 12 and a pair of second stretching wheels 11 positioned sequentially from the front opening towards the pressure wheels 10. A pair of separation plates 13 is positioned between the neighboring first and second stretching wheels 12 and 11, respectively. As the first and second fabric pieces 2 and 3 are pulled through the device 1, the first fabric piece 2 is first stretched by the first and second stretching wheels 12 and 11 at a first side of the front opening of the device 1, while the second fabric piece 3 is first stretched by the first and second stretching wheels 12 and 11 at a second side opposing to the first side of the front opening of the device 1.

Right in front of the front opening, there is a first extensible arm 15 positioned opposing to the first and second stretching wheels 12 and 11 at the first side across the first fabric piece 2. Corresponding to the firs extensible arm 15 is a second extensible arm 14 right in front of the front opening opposing to the first and second stretching wheels 12 and 11 at the second side across the second fabric piece 3. The first and second arms 15 and 14 are capable of extension in terms of their lengths towards the front opening. The first and second arms 15 and 14 are also capable of conducting high-frequency fusion.

Further in front of the first and second arms 15 and 14 is a lateral sliding rail 61 having a weight 6 movable laterally along the sliding rail 61. The third fabric piece 4 is pulled around the movable weight 6, between the first and second arms 15 and 14, and then into the front opening between the first and second fabric pieces 2 and 3.

The operation of the device 1 is as follows. First, the roller 5 is turned at an appropriate speed to pull the first, second, and third fabric pieces 2, 3, and 4, out of their respective rollers 21, 31, and 41. The tension adjustors 22, 32, and 42 maintain the first, second, and third fabric pieces 2, 3, and 4 at an appropriate tension.

Then, the second arm 14 is extended towards the first side of the front opening to push the third fabric piece 4 against the first fabric piece 2 and conducts high-frequency fusion. The second arm 14 then retracts itself while the roller 5 continues to pull the first, second, and third fabric pieces 2, 3, and 4.

Then, again, the second arm 14 is extended to push the third fabric piece 4 against the first fabric piece 2 and conducts high-frequency fusion. The second arm 14 then retracts itself while the roller 5 continues to pull the first, second, and third fabric pieces 2, 3, and 4. As such, the two lateral edges of a transparent lateral section 43 are fused to the first fabric piece 2.

The roller 5 continues to pull for an appropriate distance to skip the opaque lateral sections 44. Then, following the same procedure, the first arm 15 is extended twice to fuse the two lateral edges of a next transparent lateral section 43 to the second fabric piece 3.

The foregoing process is then continuously repeated so that the transparent lateral sections 43 are sequentially and alternately fused to the first and second fabric pieces 2 and 3, respectively, while leaving the opaque lateral sections 44 therebetween.

Please note that the provision of the laterally movable weight 6 helps to position the third fabric piece 4 so that the third fabric piece 4 could be precisely fused at predetermined intervals to the first and second fabric pieces 2 and 3.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A roller shade, comprising:
a transparent first fabric piece;
a transparent second fabric piece; and
a third fabric piece composed of a plurality of transparent and opaque lateral sections alternately pieced together along lateral edges of said transparent and opaque lateral sections;
wherein said third fabric piece is sandwiched between said first and second fabric pieces such that any two adjacent said transparent lateral sections are attached to said first and second fabric pieces, respectively, while said opaque lateral sections are thereby held between said first and second fabric pieces.

2. A method for forming a roller shade as claimed in claim 1, comprising the steps of:
pulling said first, second, and third fabric pieces from a first roller, a second roller, and a third roller, respectively, through between at least a pair of wheels;
providing a first arm and a second arm in front of said pair of wheels so that said third fabric piece is pulled through between said first and second arms, said first fabric piece is pulled through between said first arm and said wheels, and said second fabric piece is pulled through between said second arm and said wheels, said first and second arms extensible towards said second and first fabric pieces, respectively;
extending said second arm to press a first lateral edge of a transparent lateral section against said first fabric piece, conducting high-frequency fusion, retracting said second arm, pulling said first, second, and third fabric pieces for an appropriate distance, extending said second arm again to press a second lateral edge of said transparent lateral section against said first fabric piece, conducting high-frequency fusion, retracting said second arm;
pulling said first, second, and third fabric pieces for an appropriate distance to skip an opaque lateral section;
extending said first arm to press a first lateral edge of a next transparent lateral section against said second fabric piece, conducting high-frequency fusion, retracting said first arm, pulling said first, second, and third fabric pieces for an appropriate distance, extending said first arm again to press a second lateral edge of said next transparent lateral section against said second fabric piece, conducting high-frequency fusion, retracting said first arm; and
pulling said first, second, and third fabric pieces for an appropriate distance to skip a next opaque lateral section.

3. The method according to claim 2, wherein said first, second, and third fabric pieces are pulled through respective tension adjustors so that said first, second, and third fabric pieces are maintained at an appropriate tension.

4. The method according to claim 2, wherein said third fabric piece is first pulled around a moveable weight in a lateral sliding rail so as to help positioning said third fabric piece precisely.

5. The method according to claim 2, wherein said first and second arms are equipped with means for high-frequency fusion; and said high-frequency fusion for fusing said lateral edges of said transparent lateral sections of said third fabric piece to said first and second fabric pieces are directly performed by said first and second arms.
